(19) United States
(12) Patent Application Publication
(10) Pub. No.: US 2025/0119969 A1
(43) Pub. Date: Apr. 10, 2025

(54) METHOD AND APPARATUS FOR COMMUNICATION FAILURE PREDICTION AND RECOVERY

(71) Applicant: Electronics and Telecommunications Research Institute, Daejeon (KR)

(72) Inventors: Hyun Seo PARK, Daejeon (KR); Young Jin KWON, Daejeon (KR); Yunjoo KIM, Daejeon (KR); Seungjae BAHNG, Daejeon (KR); Jungbo SON, Daejeon (KR); Anseok LEE, Daejeon (KR); Yu Ro LEE, Daejeon (KR); Sung Cheol CHANG, Daejeon (KR); Heesoo LEE, Daejeon (KR)

(21) Appl. No.: 18/907,445

(22) Filed: Oct. 4, 2024

(30) Foreign Application Priority Data
Oct. 6, 2023 (KR) 10-2023-0133216
Sep. 30, 2024 (KR) 10-2024-0132562

(51) Int. Cl. H04W 76/19; H04W 24/02; H04W 36/00; H04W 74/0816

(52) U.S. Cl. CPC H04W 76/19; H04W 24/02; H04W 36/0079; H04W 74/0816

(57) ABSTRACT

An operation method of a terminal in a mobile communication system may comprise: determining whether prediction of a communication failure is needed while performing communication with a base station; in response to determining that prediction of the communication failure is required, performing a communication failure prediction procedure; and in response to predicted occurrence of the communication failure according to a result of performing the communication failure prediction procedure, performing a recovery procedure for the predicted communication failure.

### CROSS-REFERENCE TO RELATED APPLICATIONS

This application claims priority to Korean Patent Applications No. 10-2023-0133216, filed on Oct. 6, 2023, and No. 10-2024-0132562, filed on Sep. 30, 2024, with the Korean Intellectual Property Office (KIPO), the entire contents of which are hereby incorporated by reference.

### BACKGROUND

### 1. Technical Field

The present disclosure relates to a technique for predicting a communication failure and recovering from the communication failure in a mobile communication system, and more particularly, to a method and apparatus for communication failure prediction and recovery, which enhance a communication quality experienced by a user through prediction of a communication failure having a high occurrence probability and recovery from the predicted communication failure.

### 2. Related Art

In a mobile communication system, various types of communication failures may occur while a terminal and a base station are performing communication. In conventional technology, a recovery procedure is typically performed after a communication failure has occurred. When a communication failure occurs, a communication quality perceived by a user degrades, making it necessary to recover from the communication failure as quickly as possible to restore the user-perceived communication quality. Once a communication failure occurs, degradation in user-perceived communication quality is inevitable until the communication failure is detected and the recovery procedure therefor is completed.

### SUMMARY

The present disclosure for resolving the above-described problems is directed to providing a method and apparatus for predicting a communication failure having a high occurrence probability and recovering from the predicted communication failure in a mobile communication system.

According to a first exemplary embodiment of the present disclosure, an operation method of a terminal in a mobile communication system may comprise: determining whether prediction of a communication failure is needed while performing communication with a base station; in response to determining that prediction of the communication failure is required, performing a communication failure prediction procedure; and in response to predicted occurrence of the communication failure according to a result of performing the communication failure prediction procedure, performing a recovery procedure for the predicted communication failure.

The communication failure prediction procedure may be performed using an artificial intelligence/machine learning (AI/ML) model.

The operation method may further comprise: receiving configuration information for the communication failure prediction procedure from the base station, wherein the configuration information may include information on the AI/ML model.

The communication failure may be at least one of a radio link failure (RLF), a random access (RA) procedure failure, a handover failure, a reception failure, or a transmission failure.

The radio link failure may be determined to be predicted when at least one is predicted among: expiration of a T310 timer in a primary cell (PCell) or a primary secondary cell group cell (PSCell), expiration of a T312 timer in the PCell or the PSCell, random access (RA) problem from a master cell group (MCG) medium access control (MAC) layer or a secondary cell group (SCG) MAC layer, reached maximum number of retransmissions from an MCG radio link control (RLC) layer or an SCG RLC layer, or consistent uplink LBT procedure failure from the MCG MAC layer or the SCG MAC layer.

When the communication failure is a radio link failure, the radio link failure may be predicted through prediction of radio link monitoring (RLM) out-of-sync (OOS) states.

When the communication failure is a radio link failure, the radio link failure may be predicted through prediction of a consistent listen before talk (LBT) procedure failure.

When the communication failure is a radio link failure, the radio link failure may be predicted through prediction of a problem of reaching a maximum number of retransmissions in a radio link control (RLC) acknowledged mode.

When the communication failure is a radio link failure and the recovery procedure for the predicted communication failure is connection re-establishment, the connection re-establishment may be performed only when a target of the connection re-establishment is a cell other than a current serving cell.

When the communication failure is a radio link failure and a signal quality or signal strength of a current serving cell is equal to or greater than a predetermined threshold, the recovery procedure for the predicted communication failure may be a procedure for requesting resumption of connection to the current serving cell or a procedure for performing a report on the predicted communication failure to the current serving cell.

According to a second exemplary embodiment of the present disclosure, a terminal may comprise at least one processor, and the at least one processor may cause the terminal to perform: determining whether prediction of a communication failure is needed while performing communication with a base station; in response to determining that prediction of the communication failure is required, performing a communication failure prediction procedure; and in response to predicted occurrence of the communication failure according to a result of performing the communication failure prediction procedure, performing a recovery procedure for the predicted communication failure.

The communication failure prediction procedure may be performed using an artificial intelligence/machine learning (AI/ML) model.

The at least one processor may further cause the terminal to perform: receiving configuration information for the communication failure prediction procedure from the base station, wherein the configuration information may include information on the AI/ML model.

The communication failure may be at least one of a radio link failure (RLF), a random access (RA) procedure failure, a handover failure, a reception failure, or a transmission failure.

The radio link failure may be determined to be predicted when at least one is predicted among: expiration of a T310 timer in a primary cell (PCell) or a primary secondary cell group cell (PSCell), expiration of a T312 timer in the PCell or the PSCell, random access (RA) problem from a master cell group (MCG) medium access control (MAC) layer or a secondary cell group (SCG) MAC layer, reached maximum number of retransmissions from an MCG radio link control (RLC) layer or an SCG RLC layer, or consistent uplink LBT procedure failure from the MCG MAC layer or the SCG MAC layer.

When the communication failure is a radio link failure, the radio link failure may be predicted through prediction of radio link monitoring (RLM) out-of-sync (OOS) states.

When the communication failure is a radio link failure, the radio link failure may be predicted through prediction of a consistent listen before talk (LBT) procedure failure.

When the communication failure is a radio link failure, the radio link failure may be predicted through prediction of a problem of reaching a maximum number of retransmissions in a radio link control (RLC) acknowledged mode.

When the communication failure is a radio link failure and the recovery procedure for the predicted communication failure is connection re-establishment, the connection re-establishment may be performed only when a target of the connection re-establishment is a cell other than a current serving cell.

When the communication failure is a radio link failure and a signal quality or signal strength of a current serving cell is equal to or greater than a predetermined threshold, the recovery procedure for the predicted communication failure may be a procedure for requesting resumption of connection to the current serving cell or a procedure for performing a report on the predicted communication failure to the current serving cell.

In a mobile communication system, various failures may occur during communication between a terminal and a base station. When a failure occurs, a recovery procedure is typically performed. As the failure causes degradation in user-perceived communication quality, it is necessary to recover from the failure as quickly as possible to restore communication quality. In the exemplary embodiments of the present disclosure, communication failures that may occur during communication can be predicted, and recovery procedures for the predicted failures can be initiated. By predicting a communication failure before it is detected, it is possible to address the issue found in conventional communication methods where user-perceived communication quality degrades until the failure is detected and recovery procedures are initiated. However, predicting a failure and performing recovery procedures while minimizing degradation of user-perceived communication quality may result in an unnecessary use of wireless resources due to unnecessary recovery actions. Therefore, by improving the accuracy of failure predictions, unnecessary recovery procedures can be minimized, reducing the excess use of wireless resources.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a flowchart for describing a conventional method for detecting a communication failure that occurs during communication and recovering from the detected communication failure.

FIG. 4 is a flowchart for describing a method for predicting a communication failure that may occur during communication and recovering from the predicted communication failure according to exemplary embodiments of the present disclosure.

FIG. 5 is a conceptual diagram for describing a conventional procedure for detecting a radio link failure while a terminal is performing communication and recovering from the detected radio link failure.

FIGS. 6 and 7 are flowcharts illustrating a method for a terminal to predict an RLF in advance and recover from the predicted RLF according to an exemplary embodiment of the present disclosure.

FIG. 8 is a flowchart for describing a method for predicting an RLF that may occur during communication by a terminal and performing a recovery procedure for the predicted RLF according to an exemplary embodiment of the present disclosure.

FIG. 9 is a conceptual diagram for describing a conventional method in which a terminal detects Out-of-Sync (OOS) via radio link monitoring (RLM) during communication and declares an RLF after a T310 timer expires due to consecutive OOSs.

FIG. 10 is a flowchart for describing a method in which a terminal predicts an RLM OOS that may occur during communication and reports the predicted consecutive OOS problem to a higher layer according to an exemplary embodiment of the present disclosure.

FIG. 11 is a flowchart for describing a method in which a terminal predicts an RLM OOS that may occur while performing communication, predicts an RLF from predicted consecutive OOSs, and recovers from the predicted RLF according to an exemplary embodiment of the present disclosure.

FIG. 12 is a conceptual diagram for describing a conventional method in which a terminal detects an RA problem that may occur during communication and recovers from the detected RA problem.

FIG. 13 is a flowchart for describing a method in which a terminal predicts an RA problem that may occur during communication and reports the predicted RA problem to a higher layer according to an exemplary embodiment of the present disclosure.

FIG. 14 is a flowchart for describing a method in which a terminal predicts an RA problem that may occur during communication, predicts occurrence of an RLF from the predicted RA problem, and recovers from the predicted RLF according to an exemplary embodiment of the present disclosure.

FIG. 15 is a flowchart for describing a method in which a terminal predicts a handover failure that may occur during communication, and recovers from the predicted handover failure according to an exemplary embodiment of the present disclosure.

FIG. 16 is a flowchart for describing a method in which a terminal predicts an RLF of a target cell that may occur while performing communication and recovers from the predicted RLF of the target cell according to an exemplary embodiment of the present disclosure.

FIG. 17 is a flowchart for describing a method in which a terminal predicts a consistent LBT failure that may occur during communication and reports the predicted consistent LBT failure to a higher layer according to an exemplary embodiment of the present disclosure.

FIG. 18 is a flowchart for describing a method in which a terminal predicts a consistent LBT failure that may occur during communication, predicts occurrence of an RLF from the predicted consistent LBT failure, and recovers from the predicted RLF according to an exemplary embodiment of the present disclosure.

FIG. 19 is a conceptual diagram for describing a conventional method in which a terminal detects an RLC protocol error that may occur during communication and recovers from the detected protocol error.

FIG. 20 is a flowchart for describing a method in which a terminal predicts a protocol error that may occur during communication and reports a problem of the predicted protocol error to a higher layer according to an exemplary embodiment of the present disclosure.

FIG. 21 is a flowchart for describing a method in which a terminal predicts a protocol error that may occur during communication, predicts occurrence of an RLF from the predicted protocol error, and recovers from the predicted RLF according to an exemplary embodiment of the present disclosure.

FIGS. 22 and 23 are flowcharts for describing a method in which a terminal predicts a reception failure in advance and recovers from the predicted reception failure according to an exemplary embodiment of the present disclosure.

FIG. 24 is a flowchart for describing a method in which a terminal predicts a reception failure that may occur during communication and recovers from the predicted reception failure according to an exemplary embodiment of the present disclosure.

FIGS. 25 and 26 are flowcharts for describing a method in which a terminal predicts a transmission failure in advance and recovers from the predicted transmission failure according to an exemplary embodiment of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, ‘at least one of A and B’ may mean ‘at least one of A or B’ or ‘at least one of combinations of one or more of A and B’. Also, in exemplary embodiments of the present disclosure, ‘one or more of A and B’ may mean ‘one or more of A or B’ or ‘one or more of combinations of one or more of A and B’.

In exemplary embodiments of the present disclosure, ‘(re) transmission’ may mean ‘transmission’, ‘retransmission’, or ‘transmission and retransmission’, ‘(re) configuration’ may mean ‘configuration’, ‘reconfiguration’, or ‘configuration and reconfiguration’, ‘(re) connection’ may mean ‘connection’, ‘reconnection’, or ‘connection and reconnection’, and ‘(re-) access’ may mean ‘access’, ‘re-access’, or ‘access and re-access’.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

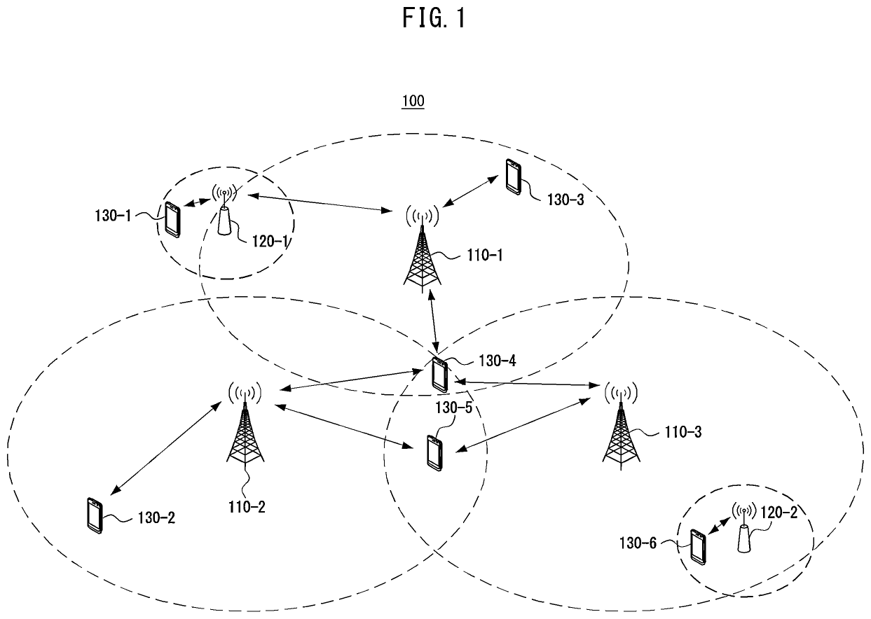

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g., a serving gateway (S-GW), a packet data network (PDN) gateway (P-GW), and a mobility management entity (MME)). When the communication system 100 is a 5G communication system (e.g., new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g., LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

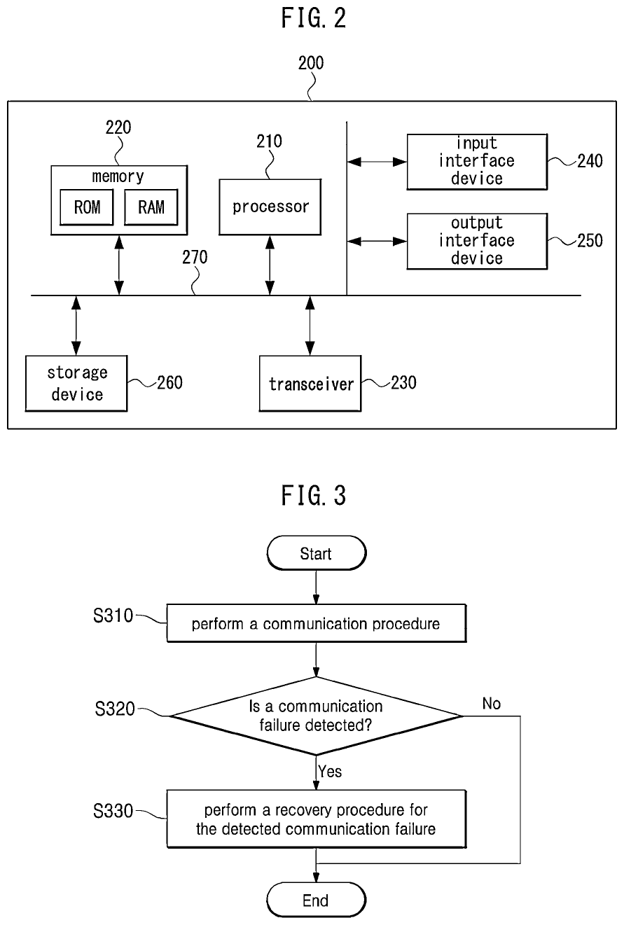

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (COMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

FIG. 3 is a flowchart for describing a conventional method for detecting a communication failure that occurs during communication and recovering from the detected communication failure.

Referring to FIG. 3, in a mobile communication system, various communication failures may occur while a terminal and a base station are communicating. According to conventional methods, the terminal and base station typically engage in communication (S310), and if a communication failure is detected (S320), a recovery procedure for the failure may be performed (S330). Therefore, when a communication failure occurs, user-perceived communication quality may deteriorate, and it can only be restored if the failure is addressed as quickly as possible. In a conventional mobile communication system, a communication failure is typically detected during communication, and a recovery procedure is performed as needed afterward. As a result, an inevitable degradation in user-perceived communication quality may occur until the failure is detected and the recovery procedure is initiated.

### Method for Predicting and Recovering Communication Failure

As described above, in a mobile communication system, various communication failures may occur while a terminal and a base station are performing communication. Exemplary embodiments of the present disclosure described below are intended to provide methods for predicting a communication failure that may occur during communication in advance and recovering from the predicted communication failure in advance. If a communication failure that may occur is predicted in advance before the communication failure is detected, the problem of the conventional method described with reference to FIG. 3 (i.e. the problem that the communication quality perceived by the user is deteriorated because the recovery procedure is initiated after the communication failure is detected) can be solved.

Meanwhile, if a communication failure is predicted in advance and a recovery procedure is performed while minimizing the degradation of communication quality perceived by the user, unnecessary wireless resource usage may increase due to unnecessary recovery procedures if the communication failure does not actually occur. Therefore, the accuracy of communication failure prediction can be increased by performing the prediction of communication failure only when the prediction of communication failure is necessary, and the recovery procedure can be performed only when the communication failure is predicted with sufficient accuracy. Through this, unnecessary recovery procedures can be minimized and unnecessary wireless resource usage can be reduced.

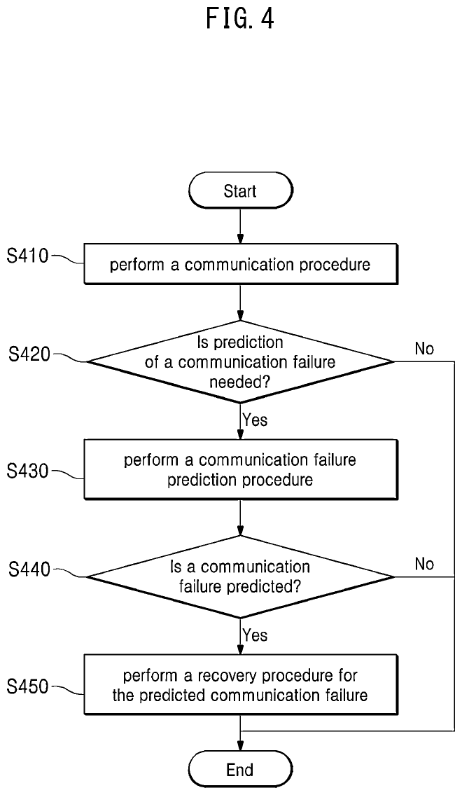

FIG. 4 is a flowchart for describing a method for predicting a communication failure that may occur during communication and recovering from the predicted communication failure according to exemplary embodiments of the present disclosure.

Referring to FIG. 4, while a terminal and a base station are communicating in a mobile communication system (S410), it may be determined whether prediction of a communication failure is needed (S420). That is, in order to prevent waste of resources due to unnecessary communication failure recovery procedures before performing prediction of a communication failure, the necessity of prediction of the communication failure is first determined in exemplary embodiments of the present disclosure. In this case, various conditions for determining the necessity of communication failure prediction are described later in exemplary embodiments below.

If a communication failure prediction is required, a communication failure prediction procedure may be performed (S430). If a communication failure is predicted (S440), a recovery procedure may be performed for the predicted communication failure (S450). In this case, the recovery procedure may be performed before the predicted communication failure occurs. In addition, the communication failure prediction procedure may be performed based on an artificial intelligence/machine learning (AI/ML) model and/or various mathematical/empirical models.

Hereinafter, specific exemplary embodiments of methods for predicting various communication failures and recovering from various predicted communication failures will be described.

### Radio Link Failure (RLF) Prediction-Based Exemplary Embodiments

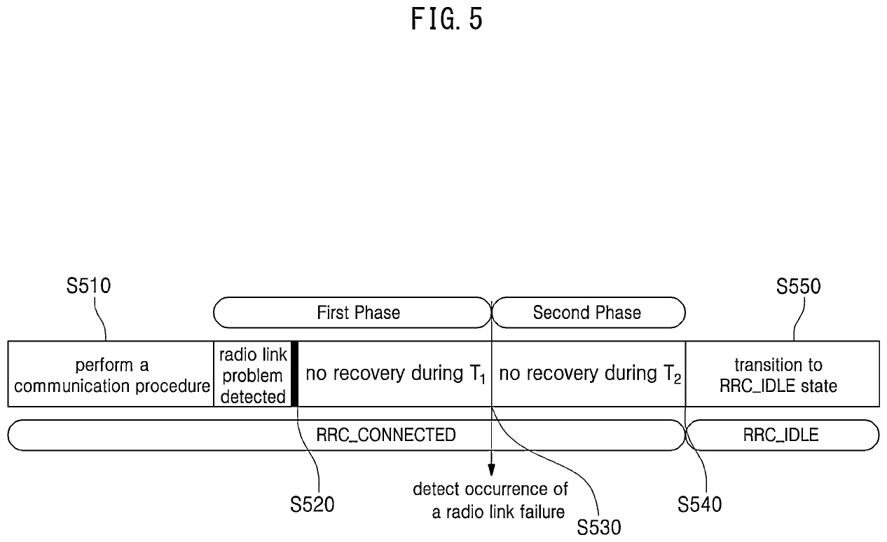

FIG. 5 is a conceptual diagram for describing a conventional procedure for detecting a radio link failure while a terminal is performing communication and recovering from the detected radio link failure.

Referring to FIG. 5, while a terminal and a base station are performing communication (S510), if a radio link problem is detected because a radio link signal quality of a serving cell is worse than a certain level, the terminal may start a T1 timer at a time the radio link problem is detected (S520). If the radio link signal quality of the serving cell improves to the certain level or better, the terminal may stop the T1 timer and continue normal communication. On the other hand, if the radio link signal quality of the serving cell does not recover to a good level and the T1 timer expires (S530), the terminal may determine that a radio link failure (RLF) has been detected and may attempt a procedure to recover from the RLF. The terminal may start a T2 timer and perform an RLF recovery procedure. If the RLF procedure is successfully performed, the terminal may continue normal communication through the recovered serving cell. However, at a time (S540) when the RLF recovery procedure is not successfully performed and the T2 timer expires, the terminal may transition to an IDLE state and attempt initial access to the network to establish a new communication connection (S550).

In the case that the RLF recovery procedure is successfully performed, a data interruption time is known to be several hundred milliseconds, and if not, the data interruption time is known to be several seconds. Typically, the T1 timer may be set to 1000 msec, and in most cases where a radio link problem occurs, since the radio link signal quality of the serving cell rarely improves to a certain level or higher while the T1 timer is running, data interruption may occur until the T1 timer expires. In order to reduce the data interruption time, the T1 timer may be set to a small value, but in a coverage hole situation where an unnecessary RLF recovery procedure may occur for a short time, a problem may occur in which the data interruption time occurs frequently for a short time.

Instead of the conventional procedure (i.e. procedure for performing the RLF recovery procedure after the RLF is detected) described with reference to FIG. 5, the terminal may predict an RLF if at least one of the following problems is predicted, and attempt a recovery procedure for the predicted RLF. That is, case(s) where the following problem(s) are predicted may be condition(s) for the terminal to determine whether RLF prediction is required. The following conditions are merely exemplary conditions, and various additional conditions that are not listed may be used.
A case of predicting a problem where a T310 timer expires in a primary cell (PCell) or a primary secondary cell group cell (PSCell)
A case of predicting a problem where a T312 timer expires in a PCell or PSCell
A case of predicting an RA problem from a master cell group (MCG) medium access control (MAC) layer or a secondary cell group (SCG) MAC layer
A case of predicting a problem of reaching the maximum number of retransmissions from an MCG radio link control (RLC) layer or SCG RLC layer
A case of predicting a problem of consistent uplink listen before talk (LBT) procedure failures from an MCG MAC layer or SCG MAC layer

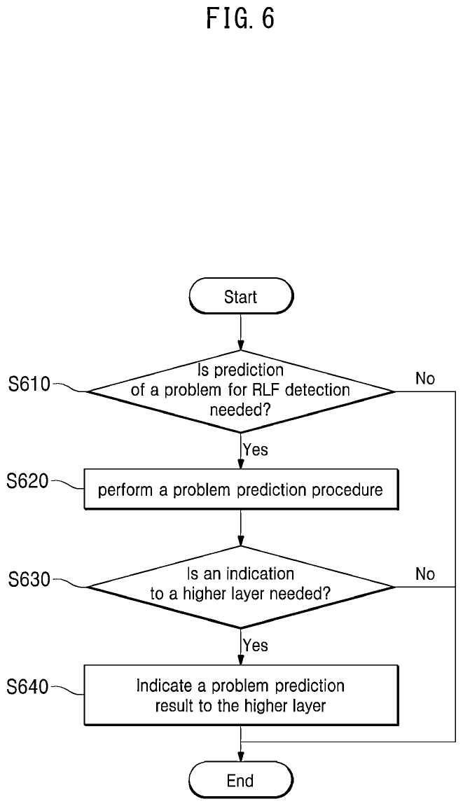

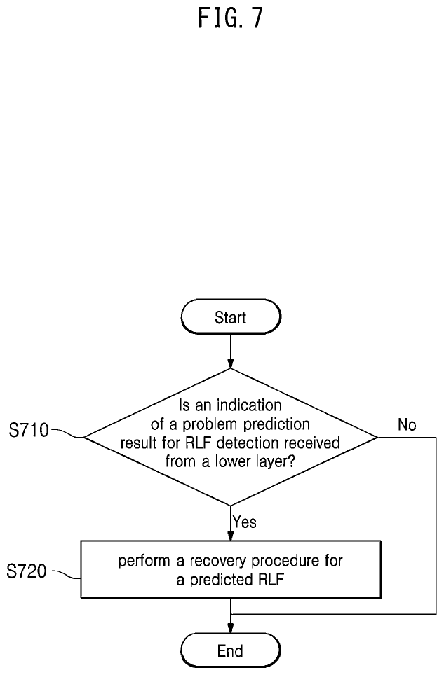

FIGS. 6 and 7 are flowcharts illustrating a method for a terminal to predict an RLF in advance and recover from the predicted RLF according to an exemplary embodiment of the present disclosure.

FIGS. 6 and 7 are intended to describe a method for predicting an RLF in advance and recovering from the predicted RLF while communication between a terminal and a base station is being performed. FIG. 6 illustrates an operation of a lower layer (e.g. physical layer, MAC layer, or RLC layer) of the terminal, and FIG. 7 illustrates an operation of a higher layer (e.g. RRC layer) of the terminal.

Referring to FIG. 6, the lower layer of the terminal may determine whether it is necessary to predict a problem for detecting an RLF (S610). If it is necessary to predict a problem for detecting an RLF, the lower layer of the terminal may perform prediction of the problem (S620). It may be determined whether it is necessary to report a result of detecting the problem to a corresponding higher layer (S630), and if it is necessary to report the result of detecting the problem, the lower layer of the terminal may report the prediction result of the problem to the corresponding higher layer (S640).

Referring to FIG. 7, the higher layer of the terminal may receive the report on the prediction result of the problem for detecting an RLF from the lower layer (S710). The higher layer of the terminal may attempt a recovery procedure for the predicted RLF (S720).

If the problem prediction is performed before detecting an RLF, the problem of data interruption time that occurs before initiating a recovery procedure after detecting an RLF can be solved, which is the problem of the existing method. If a problem for detecting an RLF is predicted and a recovery procedure is performed while minimizing the data interruption time, a problem of frequent occurrence of data interruption time for a short period of time due to unnecessary recovery procedures may occur. Therefore, prediction of a problem for detecting an RLF can be performed only when prediction of the problem is necessary, thereby increasing accuracy, and a recovery procedure can be performed only when an RLF is predicted with sufficient accuracy. In this manner, unnecessary recovery procedures can be minimized and the problem of frequent occurrence of data interruption time for a short period of time due to unnecessary recovery procedures can be solved.

Hereinafter, specific exemplary embodiments of methods of predicting a problem for detecting an RLF and reporting the problem prediction result to the higher layer to recover from the predicted RLF will be described.

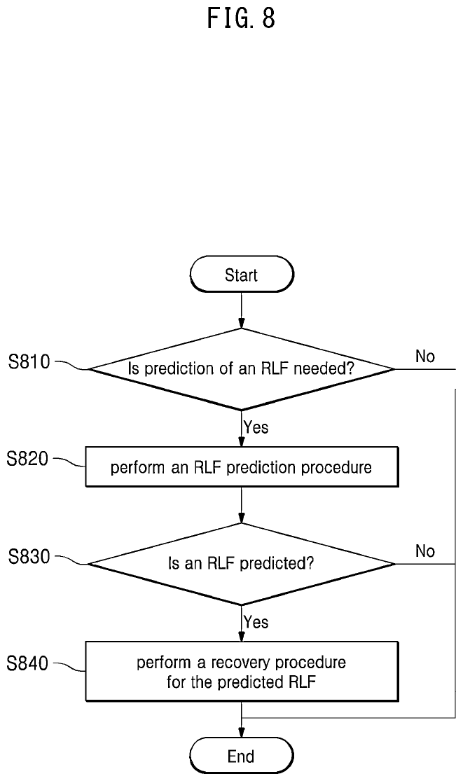

FIG. 8 is a flowchart for describing a method for predicting an RLF that may occur during communication by a terminal and performing a recovery procedure for the predicted RLF according to an exemplary embodiment of the present disclosure.

The difference between the exemplary embodiment of FIG. 8 and the exemplary embodiments of FIG. 6/7 is that, in the exemplary embodiment of FIG. 8, an RLF is directly predicted, while in the exemplary embodiments of FIG. 6/7, a problem related to detecting an RLF is predicted, thus indirectly predicting an RLF.

Referring to FIG. 8, the terminal may determine whether prediction of an RLF that may occur during communication is needed (S810). If prediction of an RLF is necessary, the terminal may perform an RLF prediction procedure (S820). The terminal may determine whether an RLF is predicted (S830), and if an RLF is predicted, the terminal may perform a recovery procedure for the predicted RLF (S840).

If prediction of an RLF is performed before the RLF is detected, the problem of data interruption time occurring before the recovery procedure for the detected RLF, which is the problem of the existing method, can be solved. If an RLF is predicted and a recovery procedure is performed while minimizing the data interruption time, a problem of frequent occurrence of data interruption time for a short period of time may occur due to unnecessary recovery procedures. Therefore, by performing RLF prediction only when the RLF prediction is necessary, the accuracy of predicting an RLF can be increased, and the recovery procedure can be performed only when the RLF is predicted with sufficient accuracy. This will minimize unnecessary recovery procedures and solve the problem of frequent short-term data interruption caused by unnecessary recovery procedures.

Meanwhile, in the case where an RLF is predicted or a problem for detecting an RLF is predicted and the RLF is detected early and a recovery procedure is attempted, the terminal may perform a cell selection procedure for a radio connection re-establishment procedure, which is a typical recovery procedure. If the current serving cell is selected in the cell selection procedure, the recovery procedure may be an unnecessary recovery procedure. Therefore, in order to reduce unnecessary recovery procedures, it may be necessary to limit the recovery procedure to be performed only when a neighbor cell, not the serving cell, is selected in the cell selection procedure. To this end, an RLF may be predicted or a problem for detecting an RLF may be predicted only when a specific condition is satisfied. In this case, the specific condition may be a case when one or more neighbor cells with better signal quality than the serving cell exist in the vicinity. Another condition may be a case when one or more neighbor cells with better signal quality than the serving cell by a specific offset or more exist in the vicinity. Another condition may be a case when one or more neighbor cells satisfy configured event condition(s) and the terminal has already transmitted a measurement report message therefor to the serving cell.

As a recovery procedure for the predicted RLF, a conventional recovery procedure for a detected RLF may be used. As a recovery procedure for a predicted handover failure or an RLF for a target cell, an RLF recovery procedure or another procedure may be performed depending on a signal quality (or signal strength) of the currently connected serving cell. If the signal quality (or signal strength) of the currently connected serving cell is not bad (i.e. if the signal quality (or signal strength) of the current serving cell is equal to or higher than a predetermined threshold), the terminal may transmit an RRCContinueRequest message to the serving cell in a connected state to request resumption of a bearer that was interrupted due to the RLF. Alternatively, the terminal may perform reporting of the predicted communication failure to the serving cell. The terminal may include in the transmitted message a predicted result for the handover failure or the RLF of the target cell. The message transmitted by the terminal may include a measurement result for neighbor cell(s) including the target cell. When the base station receives the RRCContinueRequest message from the terminal, if the base station accepts the connection resumption request of the terminal, it may transmit an RRCContinue message to the terminal and perform connection resumption. The terminal may complete the connection resumption by transmitting an RRCContinueComplete message to the base station. Alternatively, the base station may transmit an RRCReconfiguration message to the terminal to resume the connection, or transfer necessary reconfiguration information. The terminal may complete the connection resumption and reconfiguration by transmitting an RRCReconfigurationComplete message to the base station. If the received RRCReconfiguration message is a handover command to instructing handover to another target cell, the terminal may complete the connection resumption and reconfiguration by transmitting an RRCReconfigurationComplete message to a base station of the target cell. When the base station receives the RRCContinueRequest message from the terminal and does not accept the connection resumption request of the terminal, it may transmit an RRCContinueReject message to the terminal. The terminal receiving this may perform a conventional recovery procedure for a detected RLF.

### RLM OOS Prediction-Based Exemplary Embodiments

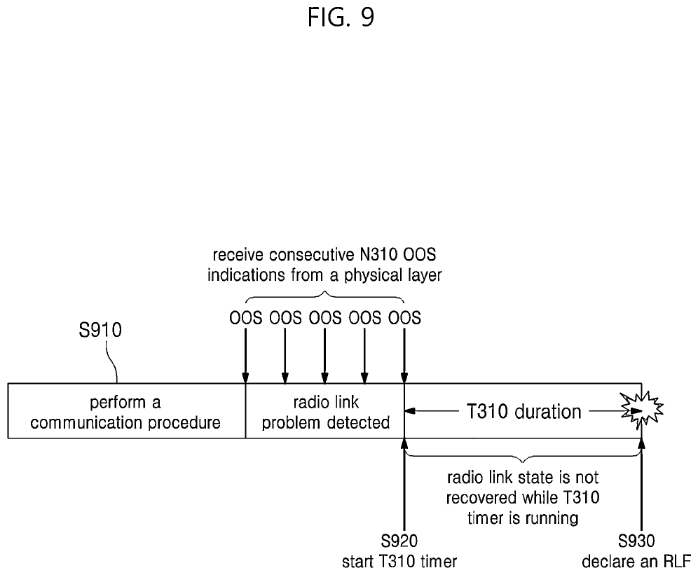

FIG. 9 is a conceptual diagram for describing a conventional method in which a terminal detects Out-of-Sync (OOS) via radio link monitoring (RLM) during communication and declares an RLF after a T310 timer expires due to consecutive OOSs.

Referring to FIG. 9, while a terminal is connected to a base station and performing communication through a primary cell (PCell), which is a special cell (SpCell), and a configured primary SCG cell (PSCell), the terminal may perform radio link monitoring (RLM) for these cells (PCell and PSCell) (S910). Thresholds (i.e. Qout and Qin) may be defined and used for radio link monitoring. Qout may be a threshold value that becomes a criterion for the terminal to enter an ‘Out of Sync (OOS)’ state, and Qin may be a threshold value that becomes a criterion for the terminal to return to an ‘In Sync (IS)’ state. Specifically, if a radio link quality falls below Qout, the terminal may determine that it cannot properly receive a physical downlink control channel (PDCCH), and if the terminal remains in the Qout state for a certain period of time, the terminal may report an RLF to the network. On the other hand, the terminal in the Qout state may returns to the IS state when the radio link quality improves to Qin or higher. The IS state is considered as a state in which the terminal can stably receive a PDCCH, and the terminal may maintain normal communication without considering an RLF any longer.

The lower layer (i.e. physical layer) of the terminal may estimate a downlink radio link quality of the corresponding cell, compare the estimated radio link quality with the thresholds, determine OOS if it is worse than Qout, determine IS if it is better than Qin, and report a result of determination to the higher layer (i.e. RRC layer). The RRC layer, which has received OOS from the physical layer consecutively the number of times indicated by the parameter N310, may determine that an RLF has occurred and may start a T310 timer (S920). While the T310 timer is running, if the radio link quality improves and the RRC layer, which has received IS from the physical layer consecutively the number of times indicated by a parameter N311, may determine that the radio link status has been recovered and may stop the T310 timer. On the other hand, if the radio link status is not recovered and the T310 timer expires (S930), the RRC layer may determine that an RLF has been detected, declare the RLF, and perform a recovery procedure for the RLF.

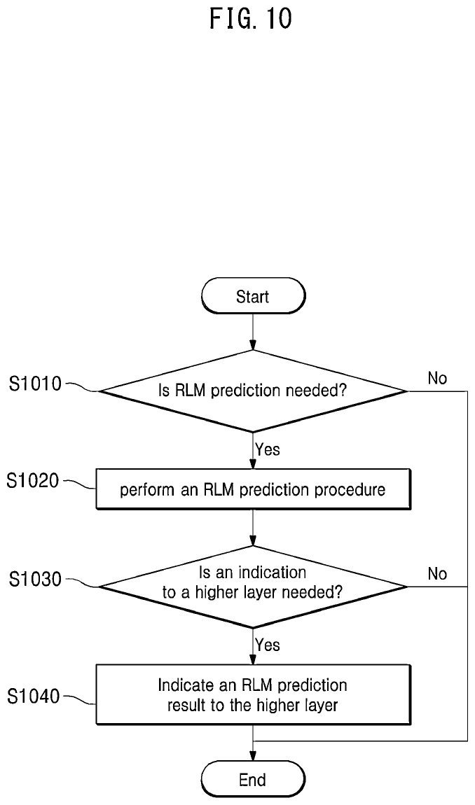

FIG. 10 is a flowchart for describing a method in which a terminal predicts an RLM OOS that may occur during communication and reports the predicted consecutive OOS problem to a higher layer according to an exemplary embodiment of the present disclosure.

Referring to FIG. 10, a terminal may determine whether prediction of an RLM OOS is needed during communication (S1010). If prediction of an RLM OOS is necessary, a lower layer (e.g. physical layer) of the terminal may perform an RLM OOS prediction procedure (S1020). The lower layer of the terminal may determine whether it is necessary to report a prediction result of an RLM OOS to a higher layer (S1030), and if reporting of the prediction result is necessary, the lower layer of the terminal may report the prediction result to the higher layer (e.g. RRC or MAC layer) (S1040). The higher layer, which has received the report of the prediction result of an RLM OOS for detecting an RLF from the lower layer of the terminal, may perform a recovery procedure for the predicted RLF.

Meanwhile, the terminal may receive configuration information for RLM OOS prediction (hereinafter, RLM OOS prediction configuration information) from the base station. The RLM OOS prediction configuration information may include whether RLM OOS prediction is performed. If the base station provides an RLM OOS prediction model, the RLM OOS prediction configuration information may include information on the RLM OOS prediction model. The RLM OOS prediction model may be an AI/ML model or various mathematical/empirical model(s). The higher layer (RRC or MAC layer) of the terminal may configure information for RLM OOS prediction in the physical layer for RLM OOS prediction.

The lower layer (e.g. physical layer) of the terminal may maintain the following parameters for RLM OOS prediction.
Noos: Number of consecutively observed OOSs
Npredon: Minimum Noos value for performing RLM OOS prediction
Noospred: Number of consecutively predicted OOSs
Nispredreset: Number of consecutively predicted ISs for resetting Noos+Noospred to 0
Nrlfind: Noos+Noospred value for reporting the RLM OOS prediction result to the higher layer

The higher layer of the terminal may set values such as Npredon, Nispredreset, and Nrlfind to the lower layer of the terminal. For example, when the values are set as Npredon=1, Nispredreset=1, and Nrlfind=6, the RLM OOS prediction result may be reported to the higher layer, as in the example of Table 1 below. In Table 1, O may indicate observed OOS, Op may indicate predicted OOS, I may indicate observed IS, Ip may indicate predicted IS, and IND may indicate reporting to the higher layer. Alternatively, the terminal may predict an SINR of the serving cell and indirectly estimate the occurrence of OOS by comparing the SINR with Qin/Qout values.

TABLE 1

| | | | | | | | | | |
|---|---|---|---|---|---|---|---|---|---|
| O/IND | Op | Op | Op | Op | Op | | | | |
| O | Op | Ip | Op | Op | Op | | | | |
| O | O | Ip | Op | Op | Op | Op | | | |
| O | O | I | | | | | | | |
| O | O | I | O | Op | Op | Op | Op | Ip | |
| O | O | I | O | O/IND | Op | Op | Op | Op | Op |

The higher layer may control the lower layer to perform RLM OOS prediction only when the above-mentioned specific condition(s) are satisfied. The base station or the terminal may activate or deactivate the RLM OOS prediction of the terminal as needed. The higher layer may activate or deactivate the RLM OOS prediction in the lower layer as needed. The higher layer that has received the RLM OOS prediction result report may attempt a recovery procedure according to a procedure similar to the procedure described with reference to FIG. 7. Alternatively, the higher layer that has received the RLM OOS prediction result report may perform prediction of an RLF according to the procedure described with reference to FIG. 8, and attempt a recovery procedure when the RLF is finally predicted.

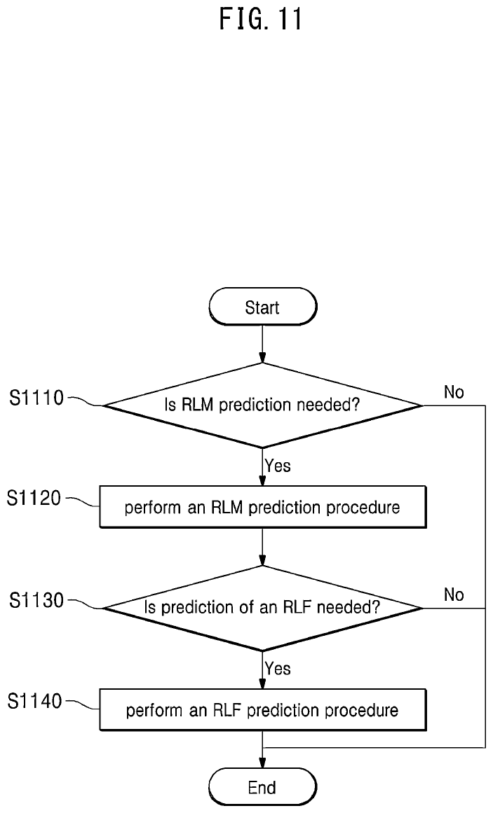

FIG. 11 is a flowchart for describing a method in which a terminal predicts an RLM OOS that may occur while performing communication, predicts an RLF from predicted consecutive OOSs, and recovers from the predicted RLF according to an exemplary embodiment of the present disclosure.

Referring to FIG. 11, the terminal may determine whether prediction of RLM OOS is needed during communication (S1110). If prediction of RLM OOS is needed, the higher layer (e.g., RRC layer) of the terminal may perform an RLM OOS prediction procedure (S1120). If an RLM OOS for detecting an RLF is predicted, the terminal may determine whether prediction of an RLF is additionally required (S1130). If prediction of an RLF is determined to be additionally required, the terminal may perform a prediction procedure of an RLF (S1140), and if the RLF is finally predicted, the terminal may attempt a recovery procedure. Alternatively, if a prediction result of RLM OOS for detecting an RLF is confirmed, the terminal may attempt a recovery procedure according to a procedure similar to the procedure described with reference to FIG. 7.

Meanwhile, the terminal may receive configuration information for RLM OOS prediction (hereinafter, RLM OOS prediction configuration information) from the base station. The RLM OOS prediction configuration information may include whether or not to perform RLM OOS prediction. If the base station provides an RLM OOS prediction model, the RLM OOS prediction configuration information may include information on the RLM OOS prediction model. The higher layer (RRC layer) of the terminal may configure information for RLM OOS prediction in the lower layer (e.g. physical layer) of the terminal for RLM OOS prediction.

The higher layer (RRC or MAC layer) of the terminal may use at least some of the following parameters for RLM OOS prediction.
Noos: Number of consecutively observed OOSs
Npredon: Minimum Noos value for performing RLM OOS prediction
Noospred: Number of consecutively predicted OOSs
Nispredreset: Number of consecutively predicted ISs for resetting Noos+Noospred to 0
Nrlfind: Noos+Noospred value for reporting the RLM OOS prediction result to the higher layer

The higher layer may be controlled to perform RLM OOS prediction only when the above-mentioned specific condition(s) are satisfied. The base station or terminal may activate or deactivate RLM OOS prediction of the terminal as needed.

### Random Access (RA) Problem Prediction-Based Exemplary Embodiments

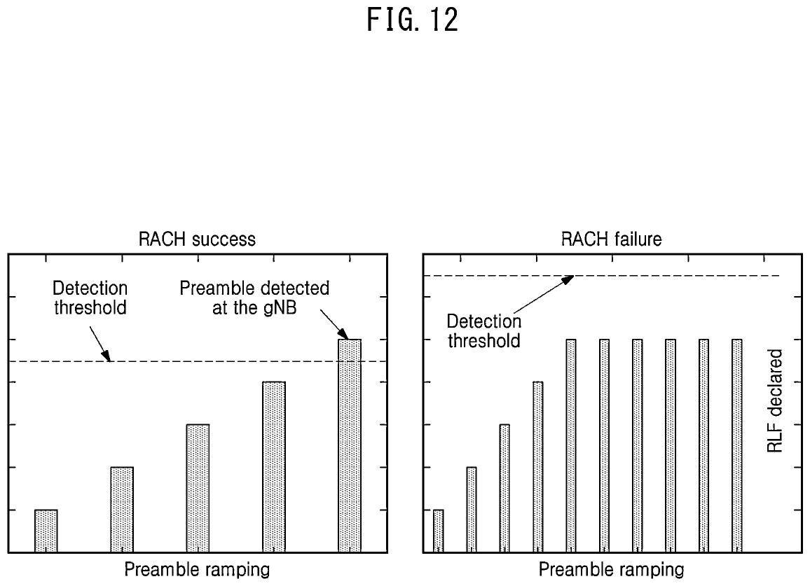

FIG. 12 is a conceptual diagram for describing a conventional method in which a terminal detects an RA problem that may occur during communication and recovers from the detected RA problem.

A terminal may attempt RA for an SpCell to access a base station. In order to control uplink interference, the terminal may initially transmit an RA preamble with a low transmission power, and if it does not receive a response thereto, may retransmit the RA preamble by slightly increasing the transmission power.

Referring to FIG. 12, the left side of FIG. 12 illustrates a case where the RA procedure is successfully performed, and the right side of FIG. 12 illustrates a case where the RA procedure fails.

Specifically, if a signal strength detected by the base station (gNB) for the RA preamble transmitted by the terminal is greater than or equal to a detection threshold, the RA procedure may be determined to be successful. On the other hand, if the signal strength detected by the base station for the RA preamble transmitted by the terminal does not reach the detection threshold despite multiple RA preamble transmissions, the RA procedure may be determined to be failed.

That is, if a radio link status with a serving cell is not good, multiple RA preamble transmissions may all fail, and when the preset maximum number of preamble transmissions is reached, a MAC layer of the terminal may report an RA problem to a higher layer. An RRC layer, which receives the RA problem from the MAC layer, may determine that an RLF has been detected and attempt a recovery procedure for the RLF.

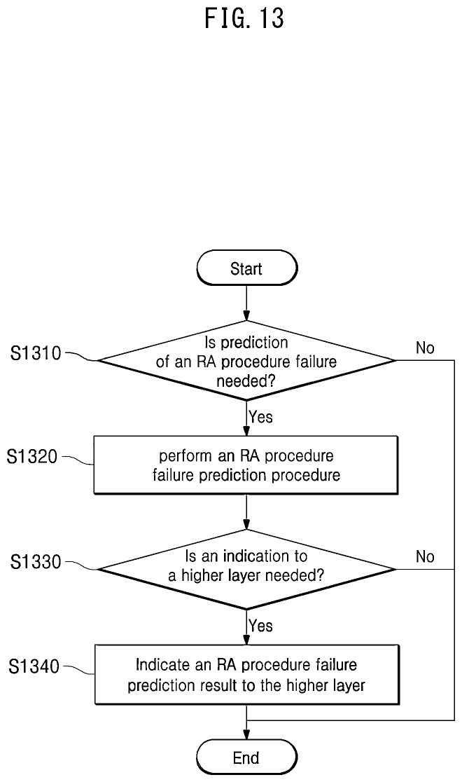

FIG. 13 is a flowchart for describing a method in which a terminal predicts an RA problem that may occur during communication and reports the predicted RA problem to a higher layer according to an exemplary embodiment of the present disclosure.

Referring to FIG. 13, a terminal may determine whether prediction of an RA procedure failure is needed while performing communication (S1310). If it is required to predict an RA procedure failure, a lower layer (e.g. MAC or physical layer) of the terminal may perform an RA procedure failure prediction procedure (S1320). The lower layer of the terminal may determine whether it is necessary to report a prediction result of the RA procedure failure to a higher layer (e.g. RRC layer) (S1330), and if reporting of the prediction result is required, the lower layer of the terminal may report the prediction result to the higher layer (S1340). The higher layer that has received the prediction result of an RA procedure failure for detecting an RLF from the MAC or physical layer may perform a recovery procedure for a predicted RLF.

Meanwhile, the terminal may receive configuration information for RA procedure failure prediction (hereinafter, RA procedure failure prediction configuration information) from the base station. The RA procedure failure prediction configuration information may include whether to perform RA procedure failure prediction. If the base station provides an RA procedure failure prediction model, the RA procedure failure prediction configuration information may include information on the RA procedure failure prediction model. The RA procedure failure prediction model may be an AI/ML model or various mathematical/empirical model(s). The higher layer (e.g. RRC layer) of the terminal may configure information for RA problem prediction in the lower layer (e.g. MAC or physical layer) of the terminal for RA procedure failure prediction.

The lower layer (e.g. MAC or physical layer) of the terminal may use at least some of the following parameters for RA procedure failure prediction.
Nraptx: Number of RA preamble transmissions
Npredon: Minimum Nraptx value for performing RA problem prediction
Nrafpred: Number of consecutive predicted RA failures
Nrafpredreset: Number of consecutive predicted RA successes for resetting Nrafpred to 0
Nrlfind: Nraptx+Nrafpred value for reporting the RA problem prediction result to the higher layer

The higher layer of the terminal may set values such as Npredon, Nrafpredreset, and Nrlfind to the lower layer (e.g. MAC or physical layer) of the terminal.

The higher layer of the terminal may control the lower layer of the terminal to perform the RA procedure failure prediction procedure only when the above-mentioned specific condition(s) are satisfied. The base station or the terminal may activate or deactivate the RA procedure failure prediction of the terminal as needed. The higher layer of the terminal may activate or deactivate the RA procedure failure prediction in the MAC or physical layer as needed.

The higher layer that has received the RA procedure failure prediction result report may attempt a recovery procedure according to a procedure similar to the procedure described with reference to FIG. 7. Alternatively, the higher layer that has received the RA procedure failure prediction result report may perform radio link failure prediction according to the procedure described with reference to FIG. 8, and attempt a recovery procedure when an RLF is finally predicted.

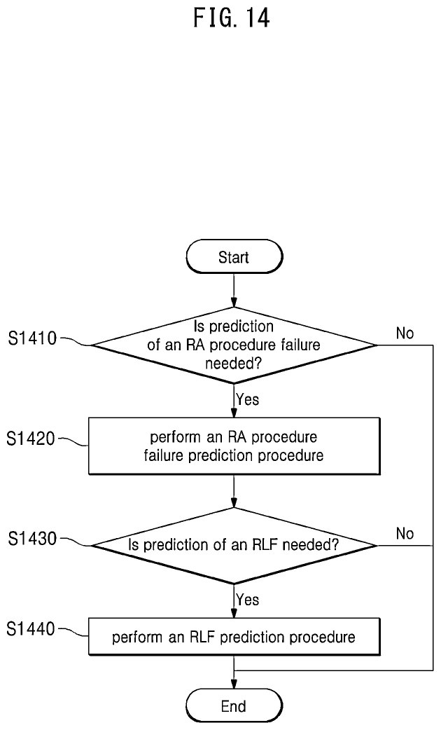

FIG. 14 is a flowchart for describing a method in which a terminal predicts an RA problem that may occur during communication, predicts occurrence of an RLF from the predicted RA problem, and recovers from the predicted RLF according to an exemplary embodiment of the present disclosure.

The difference between the exemplary embodiment of FIG. 13 and the exemplary embodiment of FIG. 14 is that in the exemplary embodiment of FIG. 13, the lower layer (e.g. MAC layer or physical layer) of the terminal performs prediction of an RA procedure failure, but in the exemplary embodiment of FIG. 14, the higher layer (e.g. RRC layer) of the terminal performs prediction of an RA procedure failure.

Referring to FIG. 14, the terminal may determine whether prediction of an RA procedure failure is needed during communication (S1410). If prediction of an RA procedure failure is required, the higher layer (e.g. RRC layer) of the terminal may perform an RA procedure failure prediction procedure (S1420). If an RA procedure failure for detecting an RLF is predicted, the terminal may determine whether prediction of an RLF is additionally required (S1430). If it is determined that additional prediction of an RLF is required, the terminal may perform an RLF prediction procedure (S1440), and if an RLF is finally predicted, the terminal may attempt a recovery procedure. Alternatively, if a result of the RA procedure failure prediction for detecting an RLF is confirmed, the terminal may attempt a recovery procedure according to a procedure similar to the procedure described with reference to FIG. 7.

Meanwhile, the terminal may receive configuration information for RA procedure failure prediction (hereinafter, RA procedure failure prediction configuration information) from the base station. If the base station provides an RA procedure failure prediction model, the RA procedure failure prediction configuration information may include information on the RA procedure failure prediction model. The RA procedure failure prediction model may be an AI/ML model or various mathematical/empirical model(s). The higher layer (e.g. RRC layer) of the terminal may maintain the following parameters for RA procedure failure prediction.
Nraptx: Number of RA preamble transmissions
Npredon: Minimum Nraptx value for performing RA problem prediction
Nrafpred: Number of consecutive predicted RA failures
Nrafpredreset: Number of consecutive predicted RA successes for resetting Nrafpred to 0
Nrlfind: Nraptx+Nrafpred value for reporting the RA problem prediction result to the higher layer

The higher layer of the terminal may set values such as Npredon, Nrafpredreset, and Nrlfind to the MAC or physical layers.

The higher layer of the terminal may be controlled to perform RA procedure failure prediction only when the above-mentioned specific condition(s) are satisfied. The base station or the terminal itself may activate or deactivate the RA procedure failure prediction of the terminal as needed.

### Handover Failure Prediction and Recovery Method

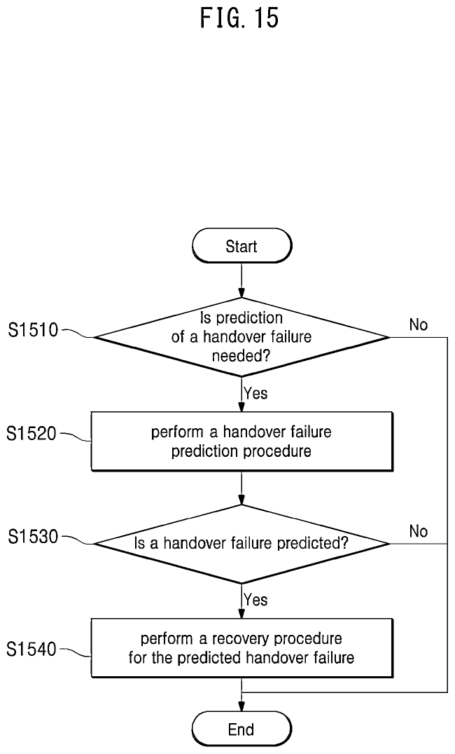

FIG. 15 is a flowchart for describing a method in which a terminal predicts a handover failure that may occur during communication, and recovers from the predicted handover failure according to an exemplary embodiment of the present disclosure.

Referring to FIG. 15, a terminal may determine whether prediction of a handover failure is needed during communication (S1510). If prediction of a handover failure is required, the higher layer (e.g. RRC layer) of the terminal may perform a handover failure prediction procedure (S1520). The terminal may determine whether a handover failure is predicted (S1530). If a handover failure is predicted, the terminal may attempt a recovery procedure according to a procedure similar to the procedure described with reference to FIG. 7. Alternatively, the terminal may request a radio connection resumption to a serving cell to which it is currently connected so that a suspended bearer may be resumed. Alternatively, the terminal may perform reporting of the predicted handover failure to the serving cell. The terminal may request the radio connection resumption by including a handover failure prediction result in a message requesting the radio connection resumption.

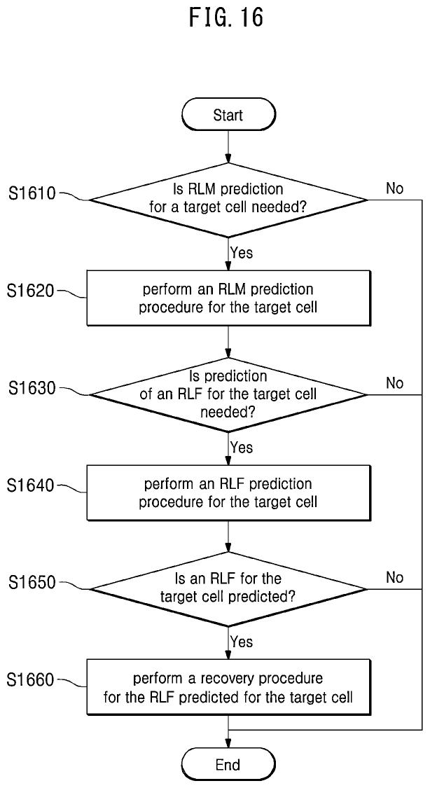

FIG. 16 is a flowchart for describing a method in which a terminal predicts an RLF of a target cell that may occur while performing communication and recovers from the predicted RLF of the target cell according to an exemplary embodiment of the present disclosure.

Referring to FIG. 16, the terminal may determine whether prediction of a radio link problem (i.e. RLM prediction) for a target cell is needed while performing communication (S1610). If RLM prediction is required for the target cell, the terminal may perform an RLM prediction procedure for the target cell (S1620). The terminal may determine whether it is required to predict an RLF of the target cell based on a result of the RLM prediction (S1630). If it is required to predict an RLF of the target cell, the higher layer (e.g. RRC layer) of the terminal may perform an RLF prediction procedure for the target cell (S1640). The terminal may determine whether an RLF for the target cell is predicted (S1650). If an RLF of the target cell is predicted, the terminal may attempt a recovery procedure according to a procedure similar to the procedure described with reference to FIG. 7 (S1660). Alternatively, the terminal may request a serving cell to which it is currently connected to resume a radio connection so that the suspended bearers can be resumed. Alternatively, the terminal may perform reporting of the predicted handover failure to the serving cell. The terminal may include the RLF prediction result for the target cell in the message transmitted to the serving cell.

### LBT Failure Prediction and Recovery Method

Meanwhile, if a listen before talk (LBT) procedure that needs to be performed for transmission in an unlicensed band repeatedly fails, the terminal may predict a final LBT failure in advance and perform a recovery procedure for the predicted LBT failure.

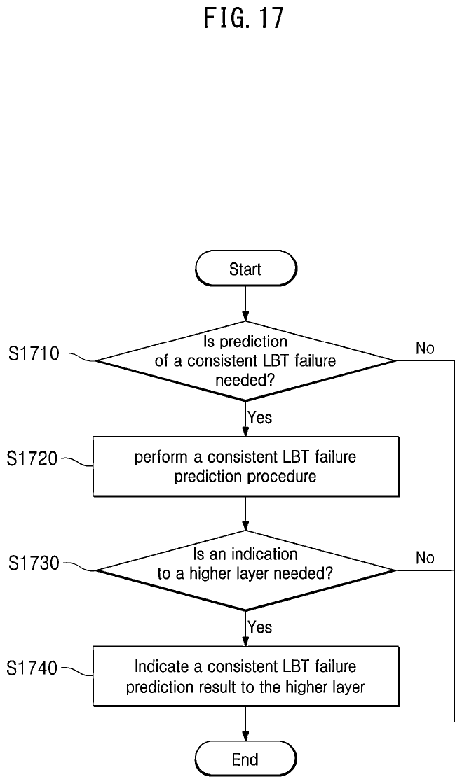

FIG. 17 is a flowchart for describing a method in which a terminal predicts a consistent LBT failure that may occur during communication and reports the predicted consistent LBT failure to a higher layer according to an exemplary embodiment of the present disclosure.

Referring to FIG. 17, a lower layer (e.g. MAC or physical layer) of a terminal may determine whether prediction of a consistent LBT failure is required during communication (S1710). If it is required to predict a consistent LBT failure, the MAC or physical layer of the terminal may perform a consistent LBT failure prediction procedure (S1720). The MAC or physical layer of the terminal may determine whether it is necessary to report a prediction result of a consistent LBT failure to a higher layer (S1730), and if reporting of the prediction result is necessary, the MAC or physical layer may report the prediction result to the higher layer (S1740). The higher layer (e.g. RRC layer) that receives the prediction result of consistent LBT procedure failure from the lower layer (e.g. MAC or physical layer) of the terminal may perform a recovery procedure for the predicted RLF.

Meanwhile, the terminal may receive configuration information for consistent LBT failure prediction from a base station (hereinafter, consistent LBT failure prediction configuration information). The consistent LBT failure prediction configuration information may include whether to perform consistent LBT failure prediction. If the base station provides a consistent LBT failure prediction model, the consistent LBT failure prediction configuration information may include information on the consistent LBT failure prediction model. The consistent LBT failure prediction model may be an AI/ML model or various mathematical/empirical model(s). The higher layer (e.g. RLC or RRC layer) of the terminal may configure information for consistent LBT failure prediction in the lower layer (e.g. MAC or physical layer) of the terminal for consistent LBT failure prediction.

The lower layer (e.g. MAC or physical layer) of the terminal may use at least some of the following parameters for consistent LBT failure prediction.
Nlbtf: Number of LBT failures
Npredon: Minimum Nlbtf value for performing consistent LBT failure prediction
Nlbtfpred: Number of consecutively predicted LBT failures
Nlbtfpredreset: Number of consecutively predicted LBT successes for resetting Nlbtfpred to 0
Nrlfind: Nlbtf+Nlbtfpred value for reporting a prediction result of consistent LBT failure to the higher layer

The higher layer of the terminal may set values such as Npredon, Nlbtfpredreset, and Nrlfind to the lower layer (e.g. MAC or physical layer) of the terminal.

The higher layer of the terminal may control the lower layer (e.g. MAC or physical layer) of the terminal to perform the consistent LBT failure prediction procedure only when the above-mentioned specific condition(s) are satisfied. The base station or the terminal may activate or deactivate the consistent LBT failure prediction of the terminal as needed. The higher layer may activate or deactivate the consistent LBT failure prediction in the lower layer (e.g. MAC or physical layer) of the terminal as needed.

The higher layer that has received the consistent LBT failure prediction result report may attempt a recovery procedure according to a procedure similar to the procedure described with reference to FIG. 7. Alternatively, the higher layer that has received the consistent LBT failure prediction result report may perform radio link failure prediction according to the procedure described with reference to FIG. 8, and attempt a recovery procedure when an RLF is finally predicted.

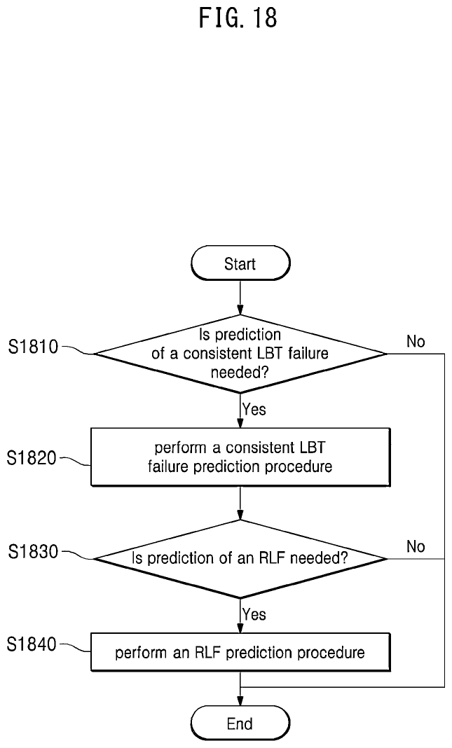

FIG. 18 is a flowchart for describing a method in which a terminal predicts a consistent LBT failure that may occur during communication, predicts occurrence of an RLF from the predicted consistent LBT failure, and recovers from the predicted RLF according to an exemplary embodiment of the present disclosure.

The difference between the exemplary embodiment of FIG. 17 and the exemplary embodiment of FIG. 18 is that in the exemplary embodiment of FIG. 17, a lower layer (e.g. MAC layer or physical layer) of a terminal performs prediction of a consistent LBT failure, but in the exemplary embodiment of FIG. 18, a higher layer (e.g. RRC layer) of the terminal performs prediction of a consistent LBT failure.

If it is required to predict a consistent LBT failure, the higher layer (e.g. RRC layer) of the terminal may perform prediction of a consistent LBT failure. If a consistent LBT failure prediction result for detecting an RLF is predicted and an RLF prediction is additionally required, RLF prediction may be performed according to the procedure of FIG. 6. If an RLF is finally predicted, a recovery procedure may be attempted. Alternatively, if a consistent LBT failure prediction result for detecting an RLF is confirmed, a recovery procedure may be attempted according to the procedure of FIG. 5.

Referring to FIG. 18, the terminal may determine whether prediction of a consistent LBT failure is needed during communication (S1810). If prediction of a consistent LBT failure is required, the higher layer (e.g. RRC layer) of the terminal may perform a consistent LBT failure prediction procedure (S1820). If a consistent LBT failure for detection of an RLF is predicted, the terminal may determine whether prediction of an RLF is additionally required (S1830). If it is determined that prediction of an RLF is additionally required, the terminal may perform an RLF prediction procedure (S1840), and if an RLF is finally predicted, the terminal may attempt a recovery procedure. Alternatively, if a consistent LBT failure prediction result for detection of an RLF is confirmed, the terminal may attempt a recovery procedure according to a procedure similar to the procedure described with reference to FIG. 7.

Meanwhile, the terminal may receive configuration information for consistent LBT failure prediction from the base station (hereinafter, consistent LBT failure prediction configuration information). The consistent LBT failure prediction configuration information may include whether to perform consistent LBT failure prediction. If the base station provides a consistent LBT failure prediction model, the consistent LBT failure prediction configuration information may include information on the consistent LBT failure prediction model. The consistent LBT failure prediction model may be an AI/ML model or various mathematical/empirical model(s). The higher layer (e.g. RRC layer) of the terminal may use at least some of the following parameters for consistent LBT failure prediction.
Nlbtf: Number of LBT failures
Npredon: Minimum Nlbtf value for performing consistent LBT failure prediction
Nlbtfpred: Number of consecutively predicted LBT failures
Nlbtfpredreset: Number of consecutively predicted LBT successes for resetting Nlbtfpred to 0
Nrlfind: Nlbtf+Nlbtfpred value for reporting a prediction result of consistent LBT failure to the higher layer

The higher layer of the terminal may be controlled to perform consistent LBT failure prediction only when the above-mentioned specific condition(s) are satisfied. The base station or the terminal itself may activate or deactivate consistent LBT failure prediction of the terminal as needed.

### Protocol Error Prediction-Based Exemplary Embodiments

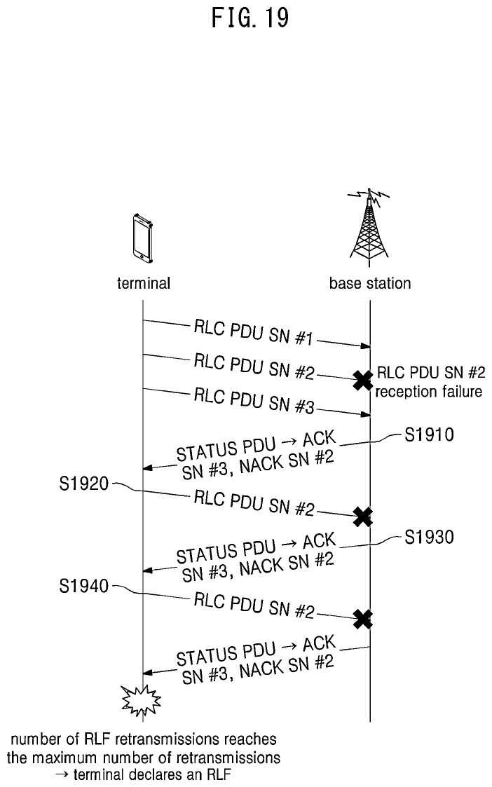

FIG. 19 is a conceptual diagram for describing a conventional method in which a terminal detects an RLC protocol error that may occur during communication and recovers from the detected protocol error.

Referring to FIG. 19, in an RLC acknowledged mode (AM), a receiving RLC entity (i.e. a receiving RLC entity of a terminal) may receive RLC protocol data units (PDUs) from a transmitting RLC entity (i.e. a transmitting RLC entity of a base station). The receiving RLC entity may transmit a STATUS protocol data unit (PDU) to inform sequence numbers (SNs) of PDUs that were not received. In the example of FIG. 19, the receiving RLC entity may indicate a reception success (ACK) for a PDU SN #3 and a reception failure (negative ACK, NACK) for a PDU SN #2 (S1910, S1930). The transmitting RLC entity that received the STATUS PDU may perform retransmission for the corresponding PDU (i.e. PDU SN #2) (S1920, S1940). However, if the number of retransmissions of the corresponding PDU (i.e., PDU SN #2) reaches the preset maximum number of retransmissions, the RLC layer may report an RLC protocol error to a higher layer. An RRC layer that received the RLC protocol error from the RLC layer may determine that an RLF has been detected and attempt a procedure to recover from the RLF.

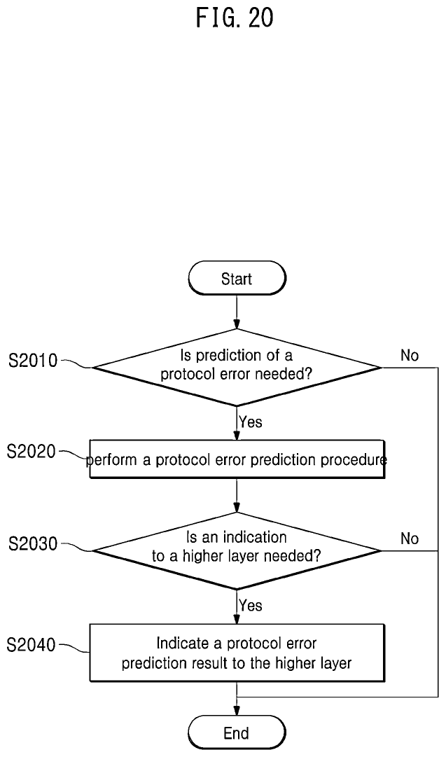

FIG. 20 is a flowchart for describing a method in which a terminal predicts a protocol error that may occur during communication and reports a problem of the predicted protocol error to a higher layer according to an exemplary embodiment of the present disclosure.

Referring to FIG. 20, an RLC layer or a layer that performs ARQ retransmission in a terminal or a base station may determine whether prediction of a protocol error is required during communication (S2010).

If prediction of a protocol error is required, the RLC layer or the layer performing ARQ retransmission may perform a protocol error prediction procedure (S2020). The RLC layer or the layer performing ARQ retransmission may determine whether it is required to report a protocol error prediction result to a higher layer (S2030), and if reporting of the prediction result is required, the layer may report the prediction result to the higher layer (S2040). The higher layer that has received the protocol error prediction result from the RLC layer or the layer performing ARQ retransmission may perform a recovery procedure for the predicted RLF.

Meanwhile, the terminal may receive configuration information for protocol error prediction (hereinafter, protocol error prediction configuration information) from the base station. The protocol error prediction configuration information may include whether to perform protocol error prediction. If the base station provides a protocol error prediction model, the protocol error prediction configuration information may include information on the protocol error prediction model. The protocol error prediction model may be an AI/ML model or various mathematical/empirical model(s). The higher layer (e.g. RRC layer) of the terminal may configure information for protocol error prediction in the RLC layer or the layer performing ARQ retransmission for protocol error prediction.

The RLC layer or the layer performing ARQ retransmission may maintain the following parameters for protocol error prediction.
Nretx: Number of PDU retransmissions
Npredon: Minimum Nretx value for performing protocol error prediction
Ntxfpred: Number of consecutive predicted transmission failures
Ntxfpredreset: Number of consecutive predicted retransmission successes for resetting Ntxfpred to 0
Nrlfind: Nretx+Ntxfpred value for reporting the protocol error prediction result to the higher layer

The higher layer of the terminal may set values such as Npredon, Ntxfpredreset, and Nrlfind to the RLC layer or the layer performing ARQ retransmission.

The higher layer of the terminal may control the RLC layer or the layer performing ARQ retransmission to perform protocol error prediction procedure only when the above-mentioned specific condition(s) are satisfied. The base station or the terminal may activate or deactivate protocol error prediction of the terminal as needed. The higher layer may activate or deactivate protocol error prediction in the RLC layer or the layer performing ARQ retransmission as needed.

The higher layer that has received the protocol error prediction result report may attempt a recovery procedure according to a procedure similar to the procedure described with reference to FIG. 7. Alternatively, the higher layer that has received the protocol error prediction result report may perform RLF prediction according to the procedure described with reference to FIG. 8, and attempt a recovery procedure when an RLF is finally predicted.

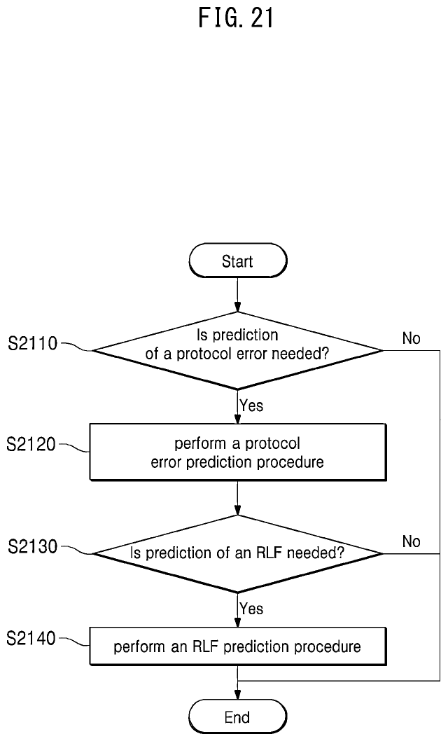

FIG. 21 is a flowchart for describing a method in which a terminal predicts a protocol error that may occur during communication, predicts occurrence of an RLF from the predicted protocol error, and recovers from the predicted RLF according to an exemplary embodiment of the present disclosure.

The difference between the exemplary embodiment of FIG. 20 and the exemplary embodiment of FIG. 21 is that in the exemplary embodiment of FIG. 20, the lower layer of the terminal (i.e. RLC layer or layer performing ARQ retransmission) performs prediction of a protocol error, but in the exemplary embodiment of FIG. 21, the higher layer (RRC layer) of the terminal performs prediction of a protocol error.

Referring to FIG. 21, the terminal may determine whether prediction of a protocol error is required during communication (S2110). If prediction of a protocol error is required, the higher layer (e.g. RRC layer) of the terminal may perform a protocol error prediction procedure (S2120). If a protocol error for detecting an RLF is predicted, the terminal may determine whether RLF prediction is additionally required (S2130). If it is determined that RLF prediction is additionally required, the terminal may perform an RLF prediction procedure (S2140), and if an RLF is finally predicted, a recovery procedure may be attempted. Alternatively, if a protocol error prediction result for detecting an RLF is confirmed, the terminal may attempt a recovery procedure according to a procedure similar to the procedure described with reference to FIG. 7.

Meanwhile, the terminal may receive configuration information for protocol error prediction (hereinafter, protocol error prediction configuration information) from the base station. If the base station provides a protocol error prediction model, the protocol error prediction configuration information may include information on the protocol error prediction model. The protocol error prediction model may be an AI/ML model or various mathematical/empirical model(s). The higher layer (e.g. RRC layer) of the terminal may maintain the following parameters for protocol error prediction.
Nretx: Number of PDU retransmissions
Npredon: Minimum Nretx value for performing protocol error prediction
Ntxfpred: Number of consecutive predicted transmission failures
Ntxfpredreset: Number of consecutive predicted retransmission successes for resetting Ntxfpred to 0
Nrlfind: Nretx+Ntxfpred value for reporting the protocol error prediction result to the higher layer

The higher layer of the terminal may be controlled to perform protocol error prediction only when the above-mentioned specific condition(s) are satisfied. The base station or the terminal itself may activate or deactivate protocol error prediction of the terminal as needed.

### Reception Failure Prediction-Based Exemplary Embodiments

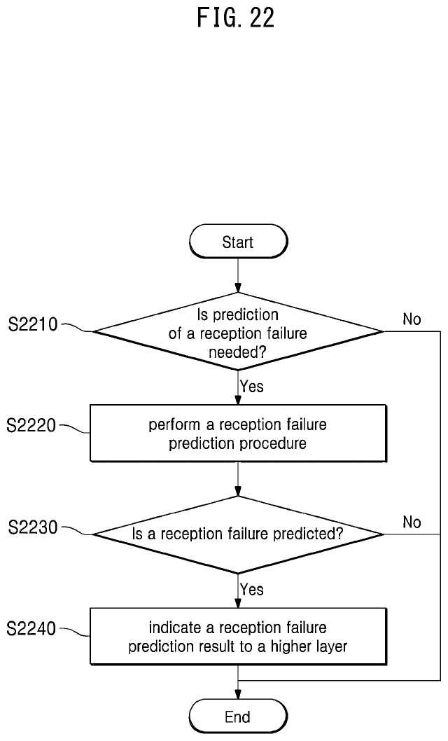

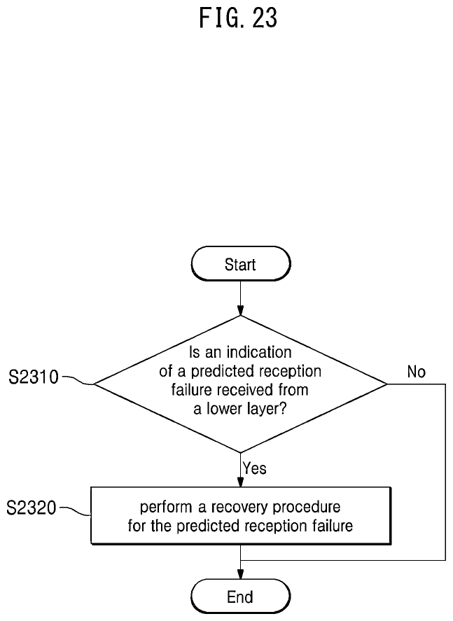

FIGS. 22 and 23 are flowcharts for describing a method in which a terminal predicts a reception failure in advance and recovers from the predicted reception failure according to an exemplary embodiment of the present disclosure.

FIGS. 22 and 23 are intended to describe a method for predicting a reception failure in advance and recovering from the predicted reception failure during communication between a terminal and a base station. FIG. 22 illustrates an operation of a lower layer (e.g. MAC or physical layer) of the terminal, and FIG. 23 illustrates an operation of a higher layer (e.g. RLC layer) of the terminal.

Referring to FIG. 22, the lower layer (e.g. MAC or physical layer) of the terminal may determine whether prediction of a reception failure is needed (S2210). If prediction of a reception failure is required, the lower layer of the terminal may perform a reception failure prediction procedure (S2220). The lower layer of the terminal may determine whether it is required to report a reception failure prediction result to the corresponding higher layer (S2230), and if it is required to report the reception failure prediction result, the lower layer of the terminal may report the reception failure prediction result to the corresponding higher layer (e.g. RLC layer) (S2240).

Referring to FIG. 23, the higher layer of the terminal may receive an indication of a predicted reception failure from the lower layer (S2310). As a method for the lower layer (e.g. MAC or physical layer) of the terminal to report the reception failure prediction result to the higher layer (e.g. RLC layer), the lower layer of the terminal may report the reception failure prediction result to all RLC entities. Alternatively, an RLC entity that wishes to receive the reception failure prediction result report may request the report to the lower layer (e.g. MAC or physical layer) of the terminal, and the lower layer of the terminal may report the reception failure prediction result to the RLC entity that requested the report. For example, if a reception failure is expected at a receiving RLC entity based on a t-Reassembly timer and received PDU sequence numbers (SNs), the receiving RLC entity may request the lower layer of the terminal to report the reception failure prediction result. If a specific HARQ process ID corresponding to a reception operation is identified, a reception failure prediction result for the HARQ process corresponding to the identified HARQ process ID may be reported. Otherwise, all reception failure prediction results may be reported. Alternatively, the receiving RLC entity may request the report in advance or implicitly to the lower layer (MAC or physical layer) of the terminal. In this case, all reception failure prediction results may be reported. If an RLC entity corresponding to a MAC SDU can be known from the MAC PDU for which a reception failure is predicted, the reception failure prediction result may be reported to the corresponding RLC entity. Alternatively, the reception failure prediction result may be reported to the corresponding RLC entity that requested the report. The higher layer of the terminal may attempt a recovery procedure for the predicted reception failure (S2320).

Meanwhile, the terminal may receive configuration information for reception failure prediction (hereinafter, reception failure prediction configuration information) from the base station. The reception failure prediction configuration information may include whether reception failure prediction is performed. When the base station provides a reception failure prediction model, the reception failure prediction configuration information may include information on the reception failure prediction model. The reception failure prediction model may be an AI/ML model or various mathematical/empirical model(s). The higher layer (e.g., RRC layer) of the terminal may configure information for reception failure prediction in the lower layer (e.g., MAC or physical layer) of the terminal.

The lower layer (e.g. MAC or physical layer) of the terminal may use at least some of the following parameters for reception failure prediction.
Ntx: the number of transmissions of the corresponding HARQ process or Nretx: the number of retransmissions of the corresponding HARQ process (Ntx=Nretx+1)
Npredon: the minimum Nretx value for performing reception failure prediction
Nrxfpred: the number of consecutively predicted reception failures
Nrxfpredreset: the number of consecutively predicted reception successes for resetting Nrxfpred to 0
Nrxfind: a variable such as Nretx+Nrxfpred value for reporting the reception failure prediction result to the higher layer

The higher layer of the terminal may set values such as Npredon, Ntxfpredreset, and Nrxfind to the lower layer (e.g. MAC or physical layer) of the terminal.

The base station or the terminal may activate or deactivate reception failure prediction of the terminal as needed. The higher layer of the terminal may activate or deactivate reception failure prediction in the lower layer (e.g. MAC or physical layer) of the terminal as needed.

Alternatively, the terminal may detect a reception failure during communication and perform a recovery procedure for the detected reception failure. If detection of a reception failure is required, the lower layer (e.g. MAC or physical layer) of the terminal may perform detection of a reception failure. If a reception failure is detected and it is required to report a reception failure detection result, the lower layer of the terminal may report the reception failure detection result to the higher layer. The higher layer that receives the report of the reception failure detection result from the lower layer of the terminal may attempt a recovery procedure for the detected reception failure.

The terminal may receive reception failure report configuration information from the base station. The reception failure report configuration information may include whether to perform reception failure detection. The higher layer (e.g. RRC layer) of the terminal may configure information for reception failure detection in the lower layer (e.g. MAC or physical layer) of the terminal.

The lower layer (e.g. MAC or physical layer) of the terminal may use at least some of the following parameters for reception failure detection.
Ntx: The number of transmissions of the corresponding HARQ process or Nretx: The number of retransmissions of the corresponding HARQ process (Ntx=Nretx+1)
Nmaxhqtx: The maximum number of HARQ transmissions

The higher layer (e.g. MAC or physical layer) of the terminal may set a value such as Nmaxhqtx to the lower layer of the terminal. For example, the terminal may determine that a reception failure occurs when Ntx>=Nmaxhqtx and reception is not successful. Alternatively, a case where the terminal receives scheduling information indicating initial transmission in a situation where it expects a retransmission may be determined as a reception failure.

The lower layer (e.g. MAC or physical layer) of the terminal may report the reception failure detection result to the higher layer (e.g. RLC layer) of the terminal in the above-described manner. The lower layer (e.g. MAC or physical layer) of the terminal may report the reception failure detection result to all RLC entities, an RLC entity that requested the report, or an RLC entity corresponding to a MAC SDU in which the reception failure is detected.

The higher layer that receives the reception failure prediction result report or reception failure detection result report may attempt a recovery procedure. For the recovery procedure, the higher layer (e.g. RLC layer) may consider the t-Reassembly timer as expired when receiving the reception failure prediction result report or reception failure detection result report. The receiving RLC AM entity may request retransmission for a reception-failed PDU more quickly by transmitting a STATUS PDU. In this manner, a time required for recovery from the reception failure can be reduced.

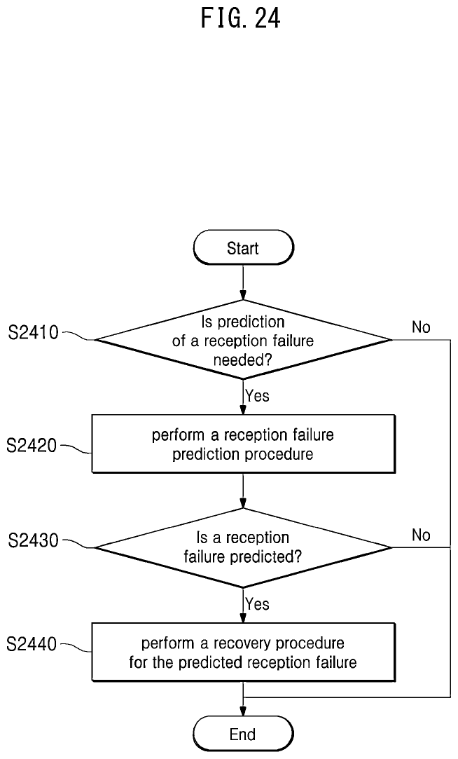

FIG. 24 is a flowchart for describing a method in which a terminal predicts a reception failure that may occur during communication and recovers from the predicted reception failure according to an exemplary embodiment of the present disclosure.

The difference between the exemplary embodiment of FIG. 24 and the exemplary embodiment of FIGS. 22/23 is that in the exemplary embodiment of FIG. 24, a reception failure is predicted in the higher layer of the terminal, but in the exemplary embodiment of FIGS. 22/23, a reception failure is predicted in the lower layer of the terminal.

Referring to FIG. 24, the terminal may determine whether prediction of a reception failure that may occur during communication is required (S2410). If prediction of a reception failure is required, the higher layer of the terminal may perform a reception failure prediction procedure (S2420). The higher layer of the terminal determines whether a reception failure is predicted (S2430), and if a reception failure is predicted, the higher layer of the terminal may perform a recovery procedure for the predicted reception failure (S2440).

Meanwhile, the terminal may receive configuration information for reception failure prediction (hereinafter, reception failure prediction configuration information) from the base station. The reception failure prediction configuration information may include whether reception failure prediction is performed. If the base station provides a reception failure prediction model, the reception failure prediction configuration information may include information on the reception failure prediction model. The reception failure prediction model may be an AI/ML model or various mathematical/empirical model(s). The higher layer (e.g. the RRC layer) of the terminal may configure information for reception failure prediction in the higher layer of the terminal (e.g. RLC layer).

The higher layer of the terminal (e.g. RLC layer) may use at least some of the following parameters for reception failure prediction.
Ntx: the number of transmissions of the corresponding HARQ process or Nretx: the number of retransmissions of the corresponding HARQ process (Ntx=Nretx+1)
Npredon: the minimum Nretx value for performing reception failure prediction
Nrxfpred: the number of consecutively predicted reception failures
Nrxfpredreset: the number of consecutively predicted reception successes for resetting Nrxfpred to 0
Nrxfind: a variable such as Nretx+Nrxfpred value for reporting the reception failure prediction result to the higher layer

The higher layer of the terminal (e.g. RRC layer) may set values such as Npredon, Ntxfpredreset, and Nrxfind to the lower layer of the terminal (e.g. RLC layer).

### Transmission Failure Prediction-Based Exemplary Embodiments

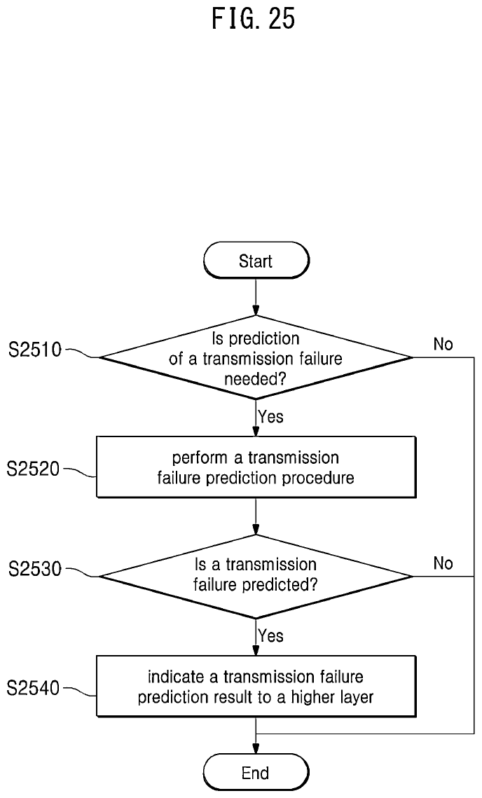

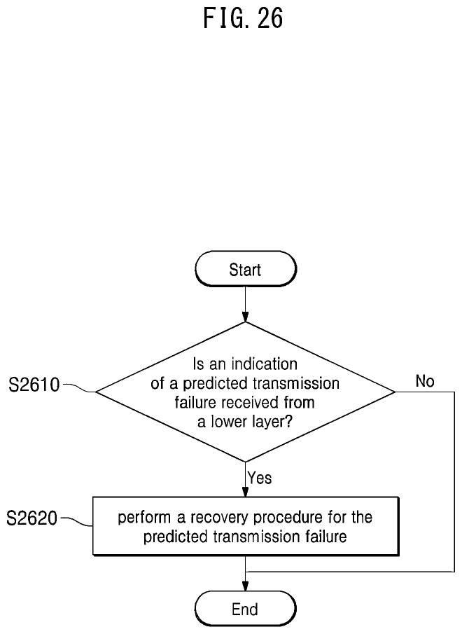

FIGS. 25 and 26 are flowcharts for describing a method in which a terminal predicts a transmission failure in advance and recovers from the predicted transmission failure according to an exemplary embodiment of the present disclosure.

FIGS. 25 and 26 are intended to described a method for predicting a transmission failure in advance and recovering from the predicted transmission failure while communication between a terminal and a base station is being performed. FIG. 25 illustrates an operation of a lower layer (e.g. MAC or physical layer) of a terminal, and FIG. 26 illustrates an operation of a higher layer (e.g. RLC layer) of the terminal.

Referring to FIG. 25, the lower layer (e.g. MAC or physical layer) of the terminal may determine whether prediction of a transmission failure is required (S2510). If prediction of a transmission failure is required, the lower layer of the terminal may perform a transmission failure prediction procedure (S2520). The lower layer of the terminal may determine whether it is required to report a transmission failure prediction result to the corresponding higher layer (S2530), and if it is required to report the transmission failure prediction result, the lower layer of the terminal may report the transmission failure prediction result to the corresponding higher layer (e.g. RLC layer) (S2540).

Referring to FIG. 26, the higher layer of the terminal may receive an indication of a predicted transmission failure from the lower layer (S2610). As a method, the transmission failure prediction result may be reported to all RLC entities corresponding to a MAC SDU for which the transmission failure is predicted. Alternatively, an RLC entity that wants to receive the report may request the report to the lower layer (e.g. MAC or physical layer) of the terminal, and the transmission failure prediction result may be reported to an RLC entity that requested the report corresponding to the MAC SDU for which the transmission failure is predicted. The higher layer of the terminal that has received the report of the predicted transmission failure result may attempt a recovery procedure for the predicted transmission failure (S2620). For the recovery procedure, when the higher layer (e.g. RLC layer) of the terminal receives the report of the predicted transmission failure result, the higher layer of the terminal may consider it as having received a STATUS PDU NACK from the receiving RLC entity for the corresponding RLC PDU. A transmitting RLC AM entity may perform rapid retransmission for the PDU that has failed to be transmitted. This can reduce a time required for recovery from the transmission failure.

Meanwhile, the terminal may receive configuration information for transmission failure prediction (hereinafter, transmission failure prediction configuration information) from the base station. The transmission failure prediction configuration information may include whether to perform transmission failure prediction. If the base station provides a transmission failure prediction model, the transmission failure prediction configuration information may include information on the transmission failure prediction model. The transmission failure prediction model may be an AI/ML model or various mathematical/empirical model(s). The higher layer (e.g. RRC layer) of the terminal may configure information for transmission failure prediction in the lower layer (e.g. MAC or physical layer) of the terminal.

The lower layer (e.g. MAC or physical layer) of the terminal may use at least some of the following parameters for transmission failure prediction.
Ntx: The number of transmissions of the corresponding HARQ process or Nretx: The number of retransmissions of the corresponding HARQ process (Ntx=Nretx+1)
Npredon: The minimum Nretx value for performing transmission failure prediction
Ntxfpred: The number of consecutively predicted transmission failures
Ntxfpredreset: The number of consecutively predicted reception successes for resetting Ntxfpred to 0
Ntxfind: The Nretx+Ntxfpred value for reporting the transmission failure prediction result to the higher layer

The higher layer of the terminal (e.g. RLC or RRC layer) may set the values such as Npredon, Ntxfpredreset, and Ntxfind to the lower layer of the terminal (e.g. MAC or physical layer).

The base station or the terminal itself may activate or deactivate transmission failure prediction of the terminal as needed. The higher layer of the terminal may activate or deactivate transmission failure prediction in the lower layer of the terminal (e.g. MAC or physical layer) as needed.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An operation method of a terminal in a mobile communication system, comprising:
determining whether prediction of a communication failure is needed while performing communication with a base station;
in response to determining that prediction of the communication failure is required, performing a communication failure prediction procedure; and
in response to predicted occurrence of the communication failure according to a result of performing the communication failure prediction procedure, performing a recovery procedure for the predicted communication failure.

2. The operation method according to claim 1, wherein the communication failure prediction procedure is performed using an artificial intelligence/machine learning (AI/ML) model.

3. The operation method according to claim 2, further comprising: receiving configuration information for the communication failure prediction procedure from the base station, wherein the configuration information includes information on the AI/ML model.

4. The operation method according to claim 1, wherein the communication failure is at least one of a radio link failure (RLF), a random access (RA) procedure failure, a handover failure, a reception failure, or a transmission failure.

5. The operation method according to claim 4, wherein the radio link failure is determined to be predicted when at least one is predicted among:
expiration of a T310 timer in a primary cell (PCell) or a primary secondary cell group cell (PSCell),
expiration of a T312 timer in the PCell or the PSCell,
random access (RA) problem from a master cell group (MCG) medium access control (MAC) layer or a secondary cell group (SCG) MAC layer,
reached maximum number of retransmissions from an MCG radio link control (RLC) layer or an SCG RLC layer, or
consistent uplink LBT procedure failure from the MCG MAC layer or the SCG MAC layer.

6. The operation method according to claim 4, wherein when the communication failure is a radio link failure, the radio link failure is predicted through prediction of radio link monitoring (RLM) out-of-sync (OOS) states.

7. The operation method according to claim 4, wherein when the communication failure is a radio link failure, the radio link failure is predicted through prediction of a consistent listen before talk (LBT) procedure failure.

8. The operation method according to claim 4, wherein when the communication failure is a radio link failure, the radio link failure is predicted through prediction of a problem of reaching a maximum number of retransmissions in a radio link control (RLC) acknowledged mode.

9. The operation method according to claim 4, wherein when the communication failure is a radio link failure and the recovery procedure for the predicted communication failure is connection re-establishment, the connection re-establishment is performed only when a target of the connection re-establishment is a cell other than a current serving cell.

10. The operation method according to claim 4, wherein when the communication failure is a radio link failure and a signal quality or signal strength of a current serving cell is equal to or greater than a predetermined threshold, the recovery procedure for the predicted communication failure is a procedure for requesting resumption of connection to the current serving cell or a procedure for performing a report on the predicted communication failure to the current serving cell.

11. A terminal comprising at least one processor, wherein the at least one processor causes the terminal to perform:
determining whether prediction of a communication failure is needed while performing communication with a base station;
in response to determining that prediction of the communication failure is required, performing a communication failure prediction procedure; and
in response to predicted occurrence of the communication failure according to a result of performing the communication failure prediction procedure, performing a recovery procedure for the predicted communication failure.

12. The terminal according to claim 11, wherein the communication failure prediction procedure is performed using an artificial intelligence/machine learning (AI/ML) model.

13. The terminal according to claim 12, wherein the at least one processor further causes the terminal to perform: receiving configuration information for the communication failure prediction procedure from the base station, wherein the configuration information includes information on the AI/ML model.

14. The terminal according to claim 11, wherein the communication failure is at least one of a radio link failure (RLF), a random access (RA) procedure failure, a handover failure, a reception failure, or a transmission failure.

15. The terminal according to claim 14, wherein the radio link failure is determined to be predicted when at least one is predicted among:
expiration of a T310 timer in a primary cell (PCell) or a primary secondary cell group cell (PSCell),
expiration of a T312 timer in the PCell or the PSCell,
random access (RA) problem from a master cell group (MCG) medium access control (MAC) layer or a secondary cell group (SCG) MAC layer,
reached maximum number of retransmissions from an MCG radio link control (RLC) layer or an SCG RLC layer, or
consistent uplink LBT procedure failure from the MCG MAC layer or the SCG MAC layer.

16. The terminal according to claim 14, wherein when the communication failure is a radio link failure, the radio link failure is predicted through prediction of radio link monitoring (RLM) out-of-sync (OOS) states.

17. The terminal according to claim 14, wherein when the communication failure is a radio link failure, the radio link failure is predicted through prediction of a consistent listen before talk (LBT) procedure failure.

18. The terminal according to claim 14, wherein when the communication failure is a radio link failure, the radio link failure is predicted through prediction of a problem of reaching a maximum number of retransmissions in a radio link control (RLC) acknowledged mode.

19. The terminal according to claim 14, wherein when the communication failure is a radio link failure and the recovery procedure for the predicted communication failure is connection re-establishment, the connection re-establishment is performed only when a target of the connection re-establishment is a cell other than a current serving cell.

20. The terminal according to claim 14, wherein when the communication failure is a radio link failure and a signal quality or signal strength of a current serving cell is equal to or greater than a predetermined threshold, the recovery procedure for the predicted communication failure is a procedure for requesting resumption of connection to the current serving cell or a procedure for performing a report on the predicted communication failure to the current serving cell.
